(19) United States
(12) Patent Application Publication
(10) Pub. No.: US 2016/0347595 A1
(43) Pub. Date: Dec. 1, 2016

(54) CHAIN HOIST

(71) Applicant: Alstom RenewableTechnologies, GRENOBLE (FR)

(72) Inventor: Sebastien VALERO LAFUENTE, Cornellà de Llobrega (ES)

(21) Appl. No.: 15/038,954

(22) PCT Filed: Nov. 24, 2014
(86) PCT No.: PCT/EP2014/075421

§ 371 Date: May 24, 2016

(30) Foreign Application Priority Data
Nov. 25, 2013 (EP) 13382471.4

(51) Int. Cl. B66D 3/26

(52) U.S. Cl. CPC B66D 3/26

(57) ABSTRACT

A hoist frame comprising a chain, a chain driving means and a chain blockage detecting device having a portion movable relative to the hoist frame and having a shaped opening for allowing the chain links to pass through and preventing the entangled chain links to pass through when the chain is driven. When the latter, occurs the movable portion is moved to the hoist frame causing a signal to be output to the chain driving means such that the chain is at least no longer driven in the same direction. A biasing means is provided to act against the movement of the movable portion by the entangled chain for delaying the signal to be output.

### TECHNICAL FIELD

A chain hoist is disclosed for hoisting and lowering objects to and from a given height. The present chain hoist is suitable for hoisting and lowering objects to and from a nacelle of a wind turbine. The present disclosure is however not limited to such particular application.

### BACKGROUND

Motor driven chain hoists are known for a very broad type of industries and places for hoisting and lowering objects up to and from 10 or 20 m. In standard applications, hoisting objects up to 30 m through chain hoists is uncommon.

In known chain hoists, one end of the chain is provided with an attaching device such as a hook or the like for attaching the chain to the object to be hoisted and the other end of the chain goes inside a rigid or flexible chain collector bag. As the chain end having the hook is hoisted, the opposite chain end, that is the slack chain descending from the overhead hoist, enters into the chain collector bag for being stored when not in use.

Such known chain hoists are typically provided with end or travel switches. For example, document CN201647893 discloses a limiting device for a chain hoist. The limiting device comprises a force supporting board that is fixed at a hoist box body. An electric limiting switch is arranged at the upper surface of the force supporting board while an elastic limiting contact point is arranged at the lower surface of the force supporting board. The chain has a hook connected through an elastic telescopic mechanism arranged under the force supporting board. The limiting structure prevents the hoist and the hook of the chain from being damaged by the collapse of the hook.

There are however specific applications where motor driven chain hoists are used to hoist objects up to more than 10 m. For example, wind turbines are one of such applications. In wind turbine applications where chains are very long, the above mentioned collector bag must be made narrow and deep in order to prevent the chain from running out of the collector bag. In such applications, the chain collector bag is provided hanging from the hoist which is located in the nacelle. However, in some cases, the chain collector bag may be separated from the chain hoist and provided hanging from a portion of the nacelle. In such cases, a guide passage is used to guide the chain into the chain collector bag.

The length of the chain in these wind turbine applications may result in problems since the chain collector bags must be very bulky to receive such long chains. In this respect, it has been found that as the slack chain enters the collector bag when a load is raised, the chain acts as a sandglass, that is, the chain is piled up to form a substantially cone shaped pile. The cone shaped pile may be built up so high that sometimes the upper links of the cone suddenly falls down to the bottom of the cone causing the chain links to become twisted or entangled. As the chain is raised from the bag when a new load is lowered, chain knots or twisted links can access the entering hole of the hoist.

Specifically, in wind turbine applications, it has been found that chain knots or link twists can be created into the chain collector bag as the chain is driven. Such chain knots or link twists can be formed regardless of whether the chain is properly lubricated. This occurrence is especially relevant in very long chains using the above mentioned narrow and deep collector bags. Although some chain knots or link twists may be undone when the chain rises up with slight tension from the collector bag towards the hoist driving wheel, there are cases in which the chain knots or link twists can remain as the chain is being raised and reach the chain entry point of the hoist. This can result in the twisted or knotted chain links to be broken when hitting the chain hoist entry point, because chain resistance significantly decreases when a link is twisted or crossed. Consequently, the load, that is, the object being handled, may fall down from a great height. This is an unacceptable risk that must be mandatorily removed especially in wind turbine applications where heavy loads and large heights are involved.

Therefore, the aim of the present disclosure is to provide a simple and effective solution to prevent chain knots, link twists or jamming from reaching the chain entry point of the hoist and therefore to prevent the chain from being broken with the above mentioned risk that a heavy load falls down from height.

### SUMMARY OF THE INVENTION

A chain hoist is provided herein that has been specially developed for wind turbine applications. Other applications where particularly long chains are used are however not ruled out.

The present chain hoist comprises a hoist frame. The hoist frame may be suitably attached permanently or temporarily in a wind turbine, for example in a wind turbine nacelle. A chain sprocket is provided having pockets shaped to fit the links of a hoist chain. The hoist chain has at least one end that is adapted to attach, for example through a hook or the like, a load to be hoisted or lowered. Driving means are also provided to move the chain, for example through the above mentioned chain sprocket.

The present chain hoist further comprises a chain blockage detecting device. The chain blockage detecting device is capable of detecting that a chain knot, link twist or jamming has been produced while the chain is being driven. The chain blockage detecting device comprises at least one portion that is movable relative to the hoist frame. The movable portion is adapted to prevent an entangled portion of the chain, that is a chain knot or link twist, from passing therethrough when the chain is driven. The movable portion is adapted to be moved by the chain knot or link twist relative to the hoist frame. This causes a signal to be output to the chain driving means such that the chain is at least no longer driven in the same direction. The output signal may result in at least one of the following actions; the chain driving means are stopped, the chain driving means are driven in a direction opposite to that of the chain just before becoming entangled, and a brake system is activated.

In an embodiment of the chain hoist, the movable portion of the chain blockage detecting device is elastic. When the chain links can not pass through the elastic movable portion of the blockage detecting device due to a chain knot or link twist as the chain is driven, the elastic movable portion is to be moved towards the hoist frame to a point in which a signal is output to the chain driving means such that the chain is at least no longer driven in the same direction. Actuation of the chain blockage detecting device on the chain driving means does not occur immediately. Due to the mechanical inertia and the operating speed of the chain driving means, the chain is not stopped immediately but it moves a little thereafter. The elastic nature of the movable portion of the chain blockage detecting device is capable of absorbing such short displacement of the chain preventing parts from being broken.

Embodiments of the movable portion of the chain blockage detecting device where it is made of plastic material are not ruled out. In such embodiments the plastic nature of the movable portion results in that the movable portion could become broken when moved to the hoist frame by chain knot or link twist as the chain is driven. This may serve to show this occurrence to the operator.

The movable portion of the chain blockage detecting device may have an opening formed therein through which a properly positioned chain can pass when driven. This opening in the movable portion of the chain blockage detecting device may be formed such that its shape at least substantially corresponds to the shape of the chain, that is, the shape of the chain links. Specifically, the opening may be cross-shaped for enabling properly positioned chain links to pass through and retaining entangled chain links preventing the chain to pass therethrough causing the movable portion of the chain blockage detecting device to be moved towards the hoist frame. This results in that a signal is output to the chain driving means such that the chain is at least no longer driven in the same direction, for example, to stop the chain.

The present chain hoist may comprise a first contact member fitted in the movable portion and a second contact member fitted to a portion that is fixed relative to the hoist frame. The second contact member may be, for example, a standard electric limit switch which is typically used for stopping the driving means when the chain has reached its end of travel such as disclosed in U.S. Pat. No. 2,778,506 or EP1616836. Such standard electric limit switch can be thus used for being contacted by the first contact member that is provided in a movable portion.

The present chain hoist may comprise biasing means to act against the movement of the movable portion caused by entangled chain links. The biasing means may comprise, for example, at least one compression spring. There might be embodiments in which the biasing means comprise several compression springs acting on different moving directions of the movable portion. The biasing means provides some flexibility to prevent the movable portion of the chain blockage detecting device from breaking or deforming. In this respect, the biasing means allow a small movement of the entangled chain during fractions of a second between the contact members contact each other so that a signal is generated and the chain driving means are stopped. This small movement of the entangled chain prevents the chain and parts of the hoist from being broken.

The biasing means provide enhanced flexibility to the system, so that damage of the chain blockage detecting device which would result from the chain movement during the delay between the moment when the signal is generated and the moment when the chain comes to a complete stop is avoided. The delay is a result of system inertias and different reaction times which prevent the instantaneous stoppage of the chain movement upon generation of the corresponding signal. If a completely rigid system were used, and taking into account that the chain knot keeps dragging the movable portion of the chain blockage detecting device during said delay time, a plastic/permanent deformation of said rigid system would occur, thus preventing further use of the system and, consequently, requiring replacement of the device after each accident involving a chain knot.

With the present chain hoist jamming such as chain knots, link twists or crossed chain links in the slack side of chain are effectively prevented from reaching the hoist frame and becoming broken. The present chain hoist has been shown to be a good safety solution which effectively replaces or complements existing safety mechanism such as limit switches or torque limiting devices (clutch devices).

It is important to note that the present chain hoist can be easily assembled both for new chain hoists and existing chain hoists for retrofitting. The present chain hoist may be applied both to collector bags hanging from the wind turbine nacelle or collector bags mounted separated from the wind turbine nacelle.

The movable portion of the chain blockage detecting device may be adapted to slide within a guide passage when the chain is entangled when being driven. Such guide passage is arranged between the hoist frame and the collector bag in embodiments in which the latter is separated from the chain hoist.

A further advantage of the present chain hoist is that it comprises small, simple, and few parts such as the above described chain blockage detecting device with a movable portion capable of outputting a signal when chain knot is detected. A cost effective solution is achieved.

Additional objects, advantages and features of embodiments of the present chain hoist will become apparent to those skilled in the art upon examination of the description, or may be learned by practice thereof.

### BRIEF DESCRIPTION OF THE DRAWINGS

Particular embodiments of the present chain hoist will be described in the following by way of non-limiting examples, with reference to the appended drawings.

In said drawings:

FIG. 1 is an elevational view of a wind turbine nacelle where the present chain hoist is mounted;

FIG. 2 is a general perspective view of the present chain hoist;

FIG. 3 is a sectional view of a first embodiment of the present chain hoist;

FIG. 3a is a top plan view of the movable portion of the chain blockage detecting device in which the opening for the chain can be seen;

FIG. 4 is a sectional view of a second embodiment of the present chain hoist;

FIG. 5 is an elevational view of a third embodiment of the present chain hoist; and

FIG. 6 is a sectional of the third embodiment of the chain hoist shown in FIG. 5.

### DETAILED DESCRIPTION

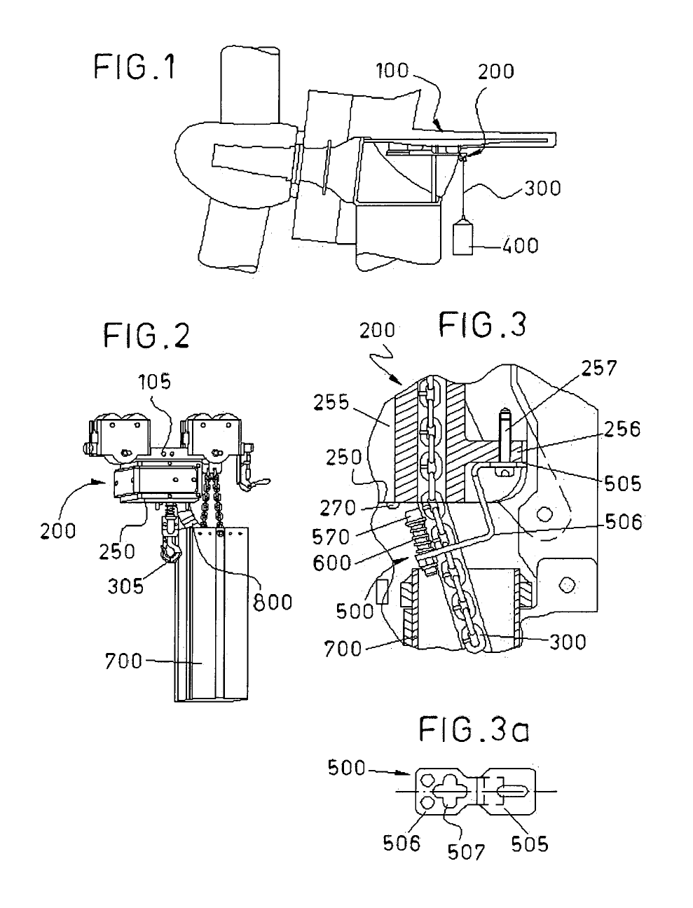

The specific embodiments of the present chain hoist shown in FIGS. 1-6 are intended to be applied to a wind turbine nacelle 100.

As shown in FIGS. 3-6, the chain hoist 200 comprises a hoist frame 250. The hoist frame 250 is attached permanently or temporarily to the wind turbine nacelle 100.

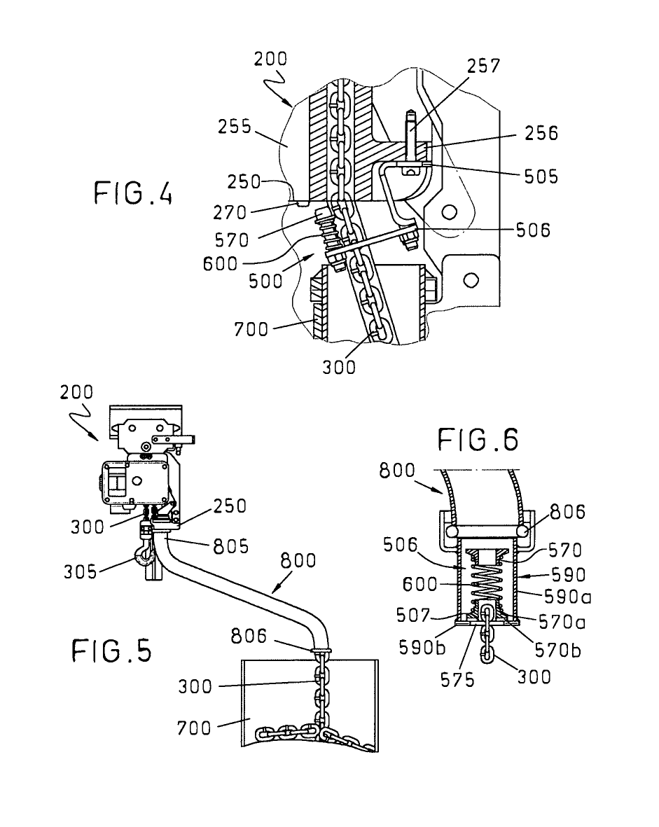

As shown in FIG. 2 of the drawings, the hoist frame 250 is in this case coupled to guide rails 105 that in turn are attached to the wind turbine nacelle 100 such that the hoist frame 250 may be moved therealong. In the embodiment shown in FIGS. 3 and 4, a guide passage 255 is provided attached to the hoist frame 250. A chain 300 is provided engaging a chain sprocket (not shown). The chain 300 can run inside the guide passage 255 moving towards or from the chain sprocket.

FIG. 2 generally shows one embodiment the chain hoist 200. The chain 300 has at least one end that is provided with a hook 305. The hook 305 is adapted to attach a load 400 to be hoisted or lowered to or from the wind turbine nacelle 100, as diagrammatically shown in FIG. 1. The other end of the chain 300 is inside a chain collector bag 700 as shown in FIG. 2. As the chain end having the hook 305 is hoisted, the opposite chain end, that is the slack chain descending from the hoist 200, enters into the chain collector bag 700 and is piled up therein.

The chain hoist 200 further comprises driving means, not shown, to move the chain 300, e.g. through the above mentioned chain sprocket, for hoisting and lowering the load 400.

The chain hoist 200 further comprises a chain blockage detecting device 500. The chain blockage detecting device 500 has a fixed portion 505 and a movable portion 506.

The fixed portion 505 of the chain blockage detecting device 500 is fixed, e.g. bolted, to the hoist frame 250. In the specific example shown, the fixed portion 505 of the chain blockage detecting device 500 is fixed to a flange 256 projecting outwards from the guide passage 255. This is carried out by standard fixing means such as bolts 257, welding, etc.

The fixed portion 505 of the chain blockage detecting device 500 extends into a movable portion 506. The fixed and movable portions 505, 506 thus define a substantially Z-shaped one-piece plate with the movable portion 506 arranged substantially inclined to the hoist frame 250 as shown in FIGS. 3 and 4. The movable portion 506 can be moved relative to the hoist frame 250 as it is elastic. As it will be explained, this occurs when jamming such as a chain knot, link twist or the like has been produced while the chain is being driven.

The movable portion 506 of the chain blockage detecting device 500 is provided with a first contact member 570. A second contact member 270 is provided fixed to the hoist frame 250. The second contact member 270 is an existing electric limit switch that is used for stopping the driving means when the chain has reached its end of travel.

The movable portion 506 of the chain blockage detecting device 500 that is present in the embodiments shown in FIGS. 3 and 4 has an opening 507 formed therein. The opening 507 is shown in detail in FIG. 3a. As it can be seen, the opening 507 is cross-shaped such it that at least substantially corresponds to the shape of the chain links. The cross shape of the opening 507 enables properly positioned chain links to pass therethrough and retains entangled chain links preventing the chain 300 to pass through the opening 507. When this occurs, the entangled chain links impact the movable portion 506 of the chain blockage detecting device 500 since they can not pass through the opening 507 as the chain 300 is being driven. This results in that the movable portion 506 of the chain blockage detecting device 500 is dragged by the chain knot or link twist causing it to be moved towards the hoist frame 250 until the first contact member 570 contacts the second contact member 270. This results in that a signal is output to the chain driving means such that the chain 300 is at least no longer driven in the same direction.

In the embodiments shown, biasing means 600 are provided acting against the movement of the movable portion 506 of the chain blockage detecting device 500 by entangled chain links. In the embodiments shown, the biasing means comprises a compression spring 600. The compression spring 600 is arranged substantially perpendicular to the movable portion 506 of the chain blockage detecting device 500. The first contact member 570 in this case is provided at one end of the spring 600.

The elastic nature of the movable portion 506 of the chain blockage detecting device 500 together with the biasing means 600 allows the short displacement of the movable portion 506 after being dragged by the chain 300 when this becomes entangled to be absorbed. The short displacement results from both mechanical inertias and communication delays. Thus, the first contact member 570 and the second contact member 270 generate a signal that is output to the chain driving means just upon contact. Nevertheless, the chain 300 cannot be stopped instantaneously for the above mentioned reasons so that a certain movement still exists.

According to the second embodiment of the chain hoist 200 shown in FIG. 4, the fixed portion 505 and the movable portion 506 of the chain blockage detecting device 500 are separate pieces. As in the first embodiment of the chain hoist 200 shown in FIG. 3, the fixed portion 505 of the chain blockage detecting device 500 is a C-shaped plate. One end of such C-shaped plate is bolted to the flange 256 in the hoist frame 250. The movable portion 506 of the chain blockage detecting device 500 is a flat plate. This flat plate is attached, e.g. bolted, to the fixed portion 505 of the chain blockage detecting device 500 at one of its ends, and arranged substantially inclined to the hoist frame 250. The movable portion 506 of the chain blockage detecting device 500 can be moved relative to the hoist frame 250 as it is elastic.

FIGS. 5 and 6 show a third embodiment of the chain hoist 200. This embodiment corresponds to a chain hoist 200 in which the chain collector bag 700 is separated from the chain hoist 200. In this embodiment, chain guide means comprising a guide passage 800 is provided to guide the chain 300 into the chain collector bag 700. One end 805 of the guide passage 800 is connected to the hoist frame 250 while an opposite end 806 of the guide passage 800 leads into the upper portion of the chain collector bag 700, as shown in FIG. 5.

In the third embodiment of the chain hoist 200, a movable chain blockage detecting device 500 is also provided. The movable chain blockage detecting device 500 includes a movable portion 506 and a fixed portion 590.

The movable portion 506 in this embodiment comprises the first contact member 570, an additional contact member 570a, a lower plate 570b and the compression spring 600 fitted therebetween. The movable portion 506 is capable of sliding within the guide passage 800 by the entangled chain as it is driven towards the hoist frame 250.

The fixed portion 590 comprises a tubular segment 590a inside of which the first contact member 570 and the additional contact member 570a are provided. A bottom plate 590b is also provided inside the fixed portion 590. This bottom plate 590b of the fixed portion 590 has an opening smaller in size than the lower plate 570b so that the latter rests thereon inside the fixed portion 590.

As in the above embodiments, a corresponding second contact member 270 is provided fixed to the hoist frame 250. Such second contact member 270, not shown in FIGS. 5 and 6, is also a standard a standard electric limit switch used for stopping the driving means when the chain 300 has reached its end to travel.

The lower plate 570b of the movable portion 506 has an opening 507 whose shape substantially corresponds to the shape of the chain links. The cross shape enables properly positioned chain links to pass through the opening 507 while retains entangled chain links. Therefore, the entangled chain 300 is prevented from being passed through the opening 507 of the lower plate 570b as the entangled chain links impact it. This results in the movable portion 506 of the device being dragged by the chain knot or link twist causing it to be displaced within the guide passage 800 towards the upper guide passage end 805, that is, towards the hoist frame 250 until the first contact member 570 in the movable portion 506 contacts the second contact member 270 in the hoist frame 250. Contact between contact member 250, 570 results in that a signal is output to the chain driving means, for example through a control unit, such that the chain 300 is no longer driven in the same direction or it is stopped thus preventing damages.

The biasing means 600 permit the relative movement between the contact members 570 and 570a. This allows absorbing the short displacement of the contact member 570a and the lower plate 570b, which results from the chain 300 still dragging the system until it comes to a complete stop. Thus, a delay exists between the generation of the signal after contact between 250 and 570 and the complete stop of the chain as certain inertias exist. If no biasing means 600 were provided and a completely rigid structure were to be used (e.g. rigid connection between 570 and 570a), the small displacement during complete stoppage of the chain would most likely result in the permanent deformation of the system.

The above described embodiments of the chain hoist 200 disclosed with the different configurations of the chain blockage detecting device 500 prevent eventual chain knots, link twists or jamming that might be created in the chain collector bag 700 from reaching and impacting the lower portion of the hoist frame 250. As stated above, when this occurs, the movable portion is dragged towards the hoist frame 250 by the entangled chain 300 until the first contact member 570 contacts the second contact member 270 resulting in that a signal is output to change the moving direction or to stop the chain driving means.

In all of the embodiments a delay exists between the moment when the signal is output after contact of contact members 570 and 270 and the moment when the system comes to a complete stop.

The signal that is output might give rise to a number of different actions. For example, when the signal is output to the chain 300, e.g. through the chain driving means, the chain 300 could be operated in the reverse direction so the chain could get back again such that the knot is undone. As a further example, when the signal is output a warning signal might be activated to that the operator is warned about jamming in the chain links.

Although only a number of particular embodiments and examples of the chain hoist have been disclosed herein, it will be understood by those skilled in the art that many other alternative embodiments and/or uses and obvious modifications and equivalents thereof are possible. The present disclosure thus covers all possible combinations of the particular embodiments described herein.

Reference signs related to drawings and placed in parentheses in a claim are solely for attempting to increase the intelligibility of the claim, and shall not be construed as limiting the scope of the claim. Thus, the scope of the present disclosure should not be limited by particular embodiments, but should be determined only by a fair reading of the claims that follow.

What is claimed is:

1. A chain hoist comprising:
a hoist frame,
a chain having at least one end adapted to attach a load to be hoisted or lowered,
driving means to move the chain; and
a chain blockage detecting device that comprises at least one portion movable relative to the hoist frame;
wherein the movable portion is adapted to prevent an entangled portion of the chain from passing therethrough when the chain is driven and to move the movable portion relative to the hoist frame by the entangled portion of the chain causing a signal to be output to the chain driving means such that the chain is at least no longer driven in the same direction.

2. Chain The chain hoist as claimed in claim 1, wherein the movable portion has an opening formed therein whose shape at least substantially corresponds to that of the chain allowing the chain links to pass through the opening and preventing the chain links to pass therethrough when at least one of the links is not properly positioned.

3. The chain hoist as claimed in claim 1, wherein it comprises a first contact member fitted in the movable portion and a second contact member fitted to a portion that is fixed relative to the hoist frame such that a signal is output to stop the chain driving means when the movable portion is moved towards the hoist frame when a chain blockage occurs such that the first contact member contacts the second contact member closing a circuit.

4. The chain hoist as claimed in claim 1, wherein it further comprises biasing means provided to absorb deformations in the movable portion produced as a consequence of the delay between signal output and actual stoppage of the chain driving means.

5. The chain hoist as claimed in claim 4, wherein the biasing means comprise at least one compression spring.

6. The chain hoist as claimed in claim 5, wherein the biasing means comprise a number of compression springs suitable for acting on different moving directions of the movable portion.

7. The chain hoist as claimed in any of the preceding claim 1, wherein the movable portion of the chain blockage detecting device is elastic.

8. The chain hoist as claimed in claim 1, wherein it further comprises guide means mounted on the hoist frame for guiding the chain when driven.

9. The chain hoist as claimed in claim 8, wherein the movable portion is adapted to slide within the chain guide means by entangled chain that is being driven.

10. The chain hoist as claimed in claim 8, wherein it further includes a chain collector bag inside of which at least part of the chain length may be stored when not in use.

11. The chain hoist as claimed in claim 10, wherein the guide passage is arranged between the hoist frame and the chain collector bag.

12. The chain hoist as claimed in claim 2, wherein it comprises a first contact member fitted in the movable portion and a second contact member fitted to a portion that is fixed relative to the hoist frame such that a signal is output to stop the chain driving means when the movable portion is moved towards the hoist frame when a chain blockage occurs such that the first contact member contacts the second contact member closing a circuit.

13. The chain hoist as claimed in claim 9, wherein it further includes a chain collector bag inside of which at least part of the chain length may be stored when not in use.
